(19) United States
(12) Patent Application Publication
(10) Pub. No.: US 2022/0147148 A1
(43) Pub. Date: May 12, 2022

(54) VIRTUAL REALITY USER INPUT SYSTEM AND METHOD

(71) Applicant: Christopher Begley, Spring Hill, FL (US)

(72) Inventor: Christopher Begley, Spring Hill, FL (US)

(21) Appl. No.: 17/096,384

(22) Filed: Nov. 12, 2020

(51) Int. Cl. G06F 3/01; G06F 3/0481; G02B 27/00; G02B 27/01; G06T 19/00; H04L 29/08

(52) U.S. Cl. CPC G06F 3/017; G06F 3/012; G06F 3/04815; H04L 67/02; G02B 27/0172; G06T 19/006; G02B 27/0093

(57) ABSTRACT

A system and method for providing a user interface device for computing systems, and more specifically, a system and method for providing user interface input devices for use with a virtual reality computing environment.

### TECHNICAL FIELD

This application relates in general to a system and method for providing a user interface device for computing systems, and more specifically, to a system and method for providing user interface input devices for use with a virtual reality computing environment.

### BACKGROUND

Current virtual reality (VR) devices (headsets/handheld controllers) allow the user to navigate an environment typically using directional joysticks or controllers attached to a handheld controller. Take for example, a walking tour through a virtual house. To get from the foyer to the kitchen, a user would move via the handheld controllers instead of walking with his/her legs.

While VR controller devices and related methods exist that allow one to walk naturally in a VR environment, these devices and related methods include cumbersome, non-portable, and expensive omni-directional treadmills or multiple, expensive tracking cameras placed about the room. Both of these methods are non-portable and expensive and limit the use of and growth of VR systems and applications.

Therefore, a need exists for a system and method for providing a user interface input device for use with a virtual reality computing environment. The present invention attempts to address the limitations and deficiencies in current VR systems according to the principles and example embodiments disclosed herein.

### SUMMARY

In accordance with the present invention, the above and other problems are solved by a system and method of providing user interface input devices for use with a virtual reality computing environment according to the principles and example embodiments disclosed herein.

In one embodiment, the present invention is a system for providing user interface input devices for use with a virtual reality computing environment.

In another embodiment it's a method for providing user interface input devices for use with a virtual reality computing environment. The method determines a set of initial user coordinates of the user within a VR space, wirelessly connect the pair of VR position sensors to the VR computing device, detect movement of one or more of the VR position sensors in response to movement of the feet by the user, determine an updated set of user coordinates based upon the movement detected in one or more of the VR position sensors, and update a visual display viewable by the user on the VR display corresponding to the updated set of user coordinates.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing user interface input devices for use with a virtual reality computing environment according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a schematic of a set of processing components for providing user interface input devices for use with a virtual reality computing environment according to the present invention.

FIG. 4 illustrates an example embodiment of a method and algorithm for providing user interface input devices for use with a virtual reality computing environment according to the present invention.

### DETAILED DESCRIPTION

This application relates in general to a system and method for providing a user interface device to processing systems, and more specifically, to a system and method for providing user interface input devices for use with a virtual reality computing environment according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “individual” and “user” refer to an entity, e.g. a human, using a user interface input device for use with a virtual reality computing environment associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), or ethernet cable(s) or wireless connection(s) using any type of frequency/frequencies or radio wave(s). Some examples are included below in this application.

The term “invention” or “present invention” refers to the invention being applied for via the patent application with the title “Virtual Reality User Input System and Method.” Invention may be used interchangeably with user input device.

The terms “communicate,” or “communication” refer to any component(s) connecting with any other component(s) in any combination for the purpose of the connected components to communicate and/or transfer data to and from any components and/or control any settings.

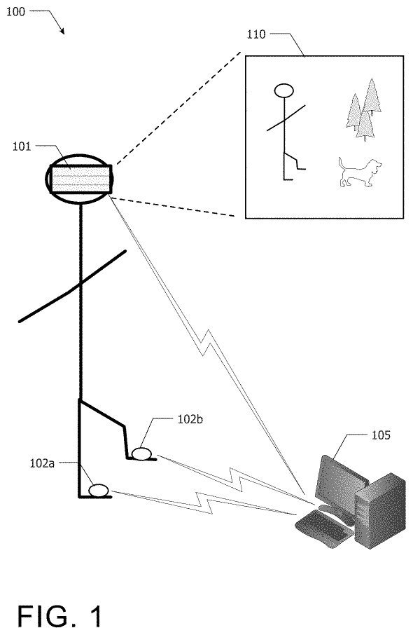

In general, the present disclosure relates to a system and method for providing user interface input devices for use with a virtual reality computing environment. To better understand the present invention, FIG. 1 illustrates a system for providing user interface input devices for use with a virtual reality computing environment according to the present invention. A VR system 100 comprises a VR processing device 105, a VR display device 101, and a pair of VR position transmitters 102a-b that are worn by a user on his or her feet. The VR processing device 105 generates VR images 110 of a virtual space in which the user may be placed within. As the user walks around the virtual space, the VR processing device 105 updates the VR images 101 seen by the user on the VR display 101 providing a visual representation of the user's motion within the virtual space.

Attachment of the VR position transmitters 102a-b onto a toe of a shoe, for example, will permit the VR position transmitters 102a-b to provide the VR processing device 105 with position location data associated with each of the user's feet as they move about a room. The user may then “walk in place” naturally. When each foot is raised and lowered, this motion constitutes a forward step in VR space. The change in position of the VR position transmitters 102a-b may be detected by the VR processing device 105. Metrics of the walking in place action are sent to the VR processing device 105 where they are processed and translated into directional data.

The VR position transmitters 102a-b may communicate with the VR processing device 105 via Bluetooth, Wi-Fi, NFC, or other wireless protocol connection. The sensors may consist of Attitude and Heading Reference Systems (AHRS)/Inertial Measurement Units (IMU) devices that are readily available. An example sensor typically uses triaxial gyroscope, accelerometer, and compass sensors in conjunction with advanced processing and on-board quaternion-based filtering algorithms to determine orientation relative to an absolute reference in real-time. Example AHRS/IMS devices may include Yost Labs' 3-Space™ sensor product, LP-research Motion Sensor LPMS-B2, and Ceva-Hillcrest Labs FSM300 9-axis IMU/AHRS module. These sensors provide fast sensor update and filter rate allow use in real-time applications, including stabilization, virtual reality, real-time immersive simulation, and robotics, highly customizable orientation sensing with options such as tunable filtering, oversampling, and orientation error correction, advanced integrated Kalman filtering allows sensor to automatically reduce the effects of sensor noise and sensor error, robust open protocol allows commands to be sent in human readable form, or more quickly in machine readable form, and an orientation output format available in absolute or relative terms in multiple formats.

Using this user input mechanism, the user can now navigate the environment intuitively. This user movement provides free navigation by the user within an enclosed VR space. By measuring the direction and distance of these steps, the system permits users to move freely as desired in the VR space.

The VR position transmitters 102a-b placed on the shoes frees up for other uses the typical handheld control inputs traditionally used for navigation including menus, environment object manipulation, communication with others, and other uses. Use of the VR position transmitters 102a-b introduces an altogether new vector for user input to VR systems 100. For example, a user can tap right toe behind him/her twice to toggle ‘run backwards’ mode, tap left toe to the left twice to toggle dodge sideways, and sweep right foot in an arc along the ground to open a closet. Many such actions and gestures may be defined by a VR application running in the VR processing device 105.

Using these input gestures, the user also may ‘run’ in place for moving at a predefined pace or speed. As such, the faster the user ‘runs in place,’ the faster the user may run through the environment. Some current VR software control mechanisms have a ‘toggle sprint’ command but a strong argument can be made that it is not as natural as actually, physically sprinting. Additionally, these prior mechanisms do not provide a variable rate of motion which may be generated by determining how fast the user is walking and running in the VR space 110.

The above gestures also may add an element of exercise to VR video games. Imagine the workout one would get when actually having to physically run and dodge during a virtual gun battle and then any fatigue experienced by the user could limit the user's later actions and response times that are detected by the VR processing system 105 using the VR position transmitters 102a-b. All of these uses make an experience within the VR space 110 more realistic.

The present invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application also may use one or more sensors to receive or send signals, such as wireless signals, for example, over Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While some of the above functions are described to be provided to users via an application on a VR processing device 105, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™, DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment in FIG. 1, various functions are shown to be performed on different programmable computing devices that communicate with each other over the Internet 111. These computing devices may include smartphones, laptop computers, tablets (not shown), and similar devices so long as the disclosed functionality of the application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC) or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

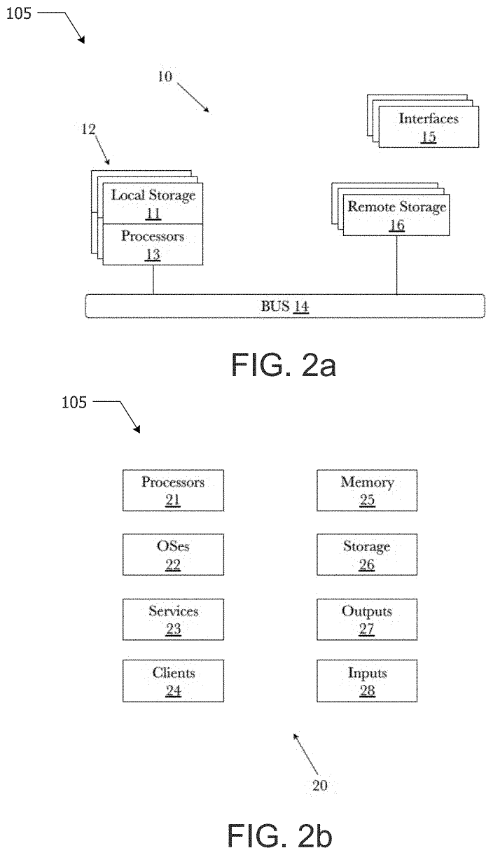

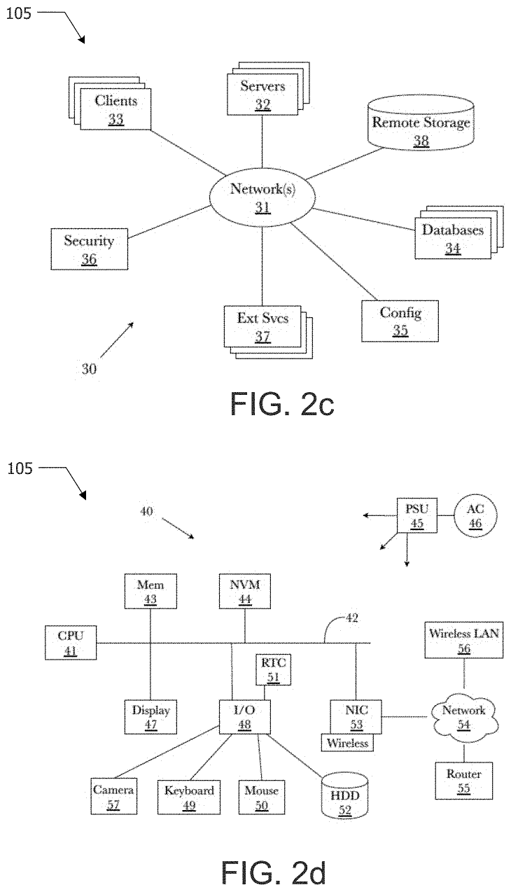

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. The computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPUs) 12, one or more interfaces 15, and one or more buses 14 (such as a peripheral component interconnect (PCI) bus). When acting under the control of appropriate software or firmware, a CPU 12 may be responsible for implementing specific functions associated with the functions of a specifically-configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC)-type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they also may include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 also may be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to a bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

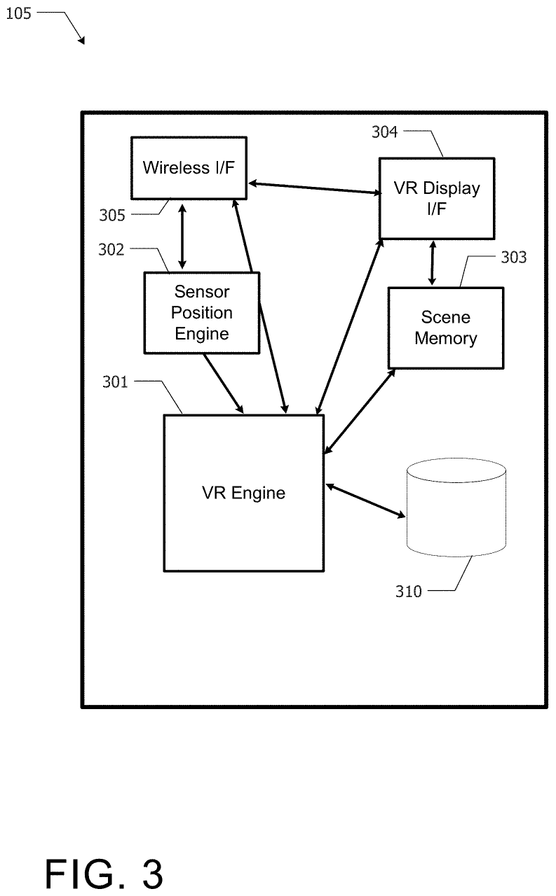

FIG. 3 illustrates an example embodiment of a schematic of a set of processing components for providing user interface input devices for use with a virtual reality computing environment according to the present invention. A VR application running within the VR processing device 105 comprises a set of processing components including a VR processing engine 301, a sensor position processor 302, a scene memory 303, a VR display interface 304, a wireless interface 305, and local data storage 310. These processing components may work together to perform the processing of the VR system 100 as disclosed herein.

The VR processing engine 301 is a central part of an application executing on the VR processing device 105. The VR processing engine 301 is responsible for generating a VR scene 110 and all of the objects and items that are visible by the user while interacting with the VR scene. The VR processing engine 301 is also responsible for updating the scene and objects within the VR space 110 as the user moves about the VR space 110 according to the present invention. The VR processing engine 301 stores and maintains the VR space 110 as data stored within the scene memory 303.

The sensor position processor 302 receives the data transmitted by the VR position transmitters 102a-b to generate the motion commands that are provided to the VR processing engine 301. The sensor position processor 302 calculates a rate of walking and running of the user as the VR position transmitters 102a-b are moved using the user's feet. the position and direction of the user's motion also may be determined with the sensor position processor 302. All of these data values are provided to the VR processing engine 301 as the data changes to permit the VR processing engine 301 to continually update the VR scene 110 to correspond to the actions of the user.

The scene memory 303 is a block of random access memory that the VR processing engine 301 fills with data that represents a current view of the VR scene 110 as viewed from a current position of the user in the VR space. The content of the screen memory 303 is subsequently used to transmit images to the VR display 101 for viewing by the user.

The VR display interface 304 accepts VR scene data from the scene memory 303 to generate images displayed to the user by the VR display 101. The VR display interface 304 may be configured to match a particular VR display device 101 such that a generic representation of the VR scene 110 always may be generated by the VR processing engine 101. The VR display interface 304 may make modifications to the scene data retrieved from the scene memory 303 to be properly viewable on different display devices. For example, different display devices may possess different image resolutions, different color spaces, different spatial fields of view, and different update rates. The VR processing engine 301 may maintain the VR scene 110 in the scene memory 303 while permitting the VR display interface 304 to adjust the images as needed before they are presented to the user. The VR display interface 304 also may provide communications between the VR processing device 105 and the VR display 101; for example, a wireless communications channel for transmission of the images.

The wireless interface 305 provides a connection between the VR processing device 105 and the VR position transmitters 102a-b, the VR display device 101, and other processing systems including the Internet. The wireless interface 305 also performs all necessary data formatting, data packet creation, data encryption for security, and data transmission and reception when the VR processing device 105 communicates with other processing systems disclosed herein.

The local data storage 310 provides the VR processing device 105 with permanent mass storage to maintain user data, VR scenes, current state data for various VR scenes, definition data for objects, object motion and interaction, and other data used by any of the processing components disclosed herein. Any processing libraries and related processing instructions also may be included in the data stored on the local data storage.

The VR processing device 105 also may include processing components and related hardware devices to permit the VR processing device 105 communicate with other VR processing systems in use by other users. This communications may be over a local area network, a wireless or cellular network, and the Internet to allow users to simultaneously interact with each other within a common VR space 110. Other interfaces and processing components to gaming systems and other computing systems also may be included within the VR processing device 105 using standard communication protocols and processing methods.

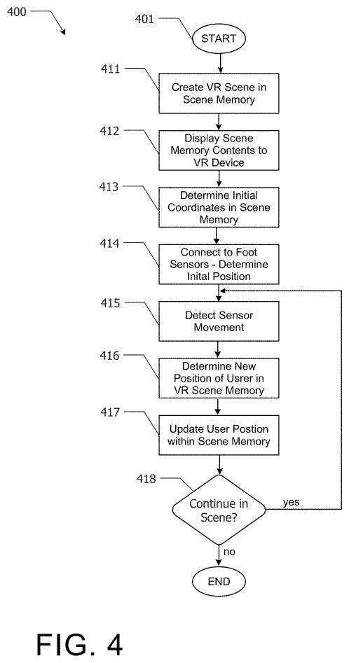

FIG. 4 illustrates an example embodiment of a method and algorithm for providing user interface input devices for use with a virtual reality computing environment according to the present invention. The VR processing device 105 performs the processing steps of process 400 to provide the VR user input according to the present invention as disclosed herein.

The process 400 begins 401 and a VR scene data is created by the VR processing engine 301 and stored into the scene memory 303 in step 411. Next, the VR processing device 105 connects to the VR display device 101 in step 412 to display the scene stored within the scene memory 303 onto the VR display device 101. A current position of the user within the VR scene is determined and loaded into the scene memory 303 in step 413.

In step 414, the VR processing device 105 connects to the VR position transmitters 102a-b to initialize their position within the VR scene 110 and begin transmitting positional change data. The VR processing device 15 detects a sensor position movement from the data received from the VR position transmitters 102a-b in step 415. The VR processing device in step 416 determines a new position of the user within the VR scene 110 including a rate of movement and any interaction with other objects within the VR scene 110. Using the new position data determined in step 416, the VR processing device 105 updates the user position, orientation and interaction with objects as represented by data stored in the scene memory 303 in step 417. The updates to the scene memory 303 cause the VR display interface 304 to modify the images presented to the user by the VR display device 101.

Test step 418 causes the VR processing device 105 to determine whether or not the process 400 is to continue as the user continues in the VR scene 110. When the VR processing device 105 determines that the process 400 is to continue in test step 418, the process 400 returns to step 415 to detect the next movement of the VR position transmitters 102a-b; otherwise, the process 400 ends 402.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communications or transfer of content(s) or data between any combination of the components.

What is claimed is:

1. A system for providing user interface input devices for use with a virtual reality computing environment, the computing environment having a virtual reality (VR) computing device communicatively connected to a VR display, and a pair of VR position sensors attached to user about each foot, the VR computing device comprising:
a memory having instructions stored thereon; and
a processor configured to execute the instructions on the memory to cause the web server to:
determine a set of initial user coordinates of the user within a VR space;
wirelessly connect the pair of VR position sensors to the VR computing device;
detect movement of one or more of the VR position sensors in response to movement of the feet by the user;
determine an updated set of user coordinates based upon the movement detected in one or more of the VR position sensors; and
update a visual display viewable by the user on the VR display corresponding to the updated set of user coordinates.

2. The system according to claim 1, wherein the pair of VR position sensors comprise Attitude and Heading Reference Systems (AHRS)/Inertial Measurement Units (IMU) devices.

3. The system according to claim 2, wherein the VR position sensors generate a 9-axis position data corresponding to a present position of the VR position sensor.

4. The system according to claim 1, wherein the visual display viewable by the user on the VR display is generates using VR space data stored within a block of scene memory containing VR object data representing objects, individuals, and the user as virtual objects in the VR space.

5. The system according to claim 4, wherein the initial set of user coordinates and the updated set of user coordinates correspond to spatial positions within the VR space as defined by the VR object data stored within the block of scene memory.

6. A method for providing user interface input devices for use with a virtual reality computing environment, the computing environment having a computing device communicatively connected to a virtual reality display, the method comprising:
determining a set of initial user coordinates of the user within a VR space;
wirelessly connecting the pair of VR position sensors to the VR computing device;
detecting movement of one or more of the VR position sensors in response to movement of the feet by the user;
determining an updated set of user coordinates based upon the movement detected in one or more of the VR position sensors; and
updating a visual display viewable by the user on the VR display corresponding to the updated set of user coordinates.

7. The method according to claim 6, wherein the pair of VR position sensors comprise Attitude and Heading Reference Systems (AHRS)/Inertial Measurement Units (IMU) devices.

8. The method according to claim 7, wherein the VR position sensors generate a 9-axis position data corresponding to a present position of the VR position sensor.

9. The method according to claim 6, wherein the visual display viewable by the user on the VR display is generates using VR space data stored within a block of scene memory containing VR object data representing objects, individuals, and the user as virtual objects in the VR space.

10. The method according to claim 9, wherein the initial set of user coordinates and the updated set of user coordinates correspond to spatial positions within the VR space as defined by the VR object data stored within the block of scene memory.
